(19) United States
(12) Patent Application Publication
(10) Pub. No.: US 2018/0321877 A1
(43) Pub. Date: Nov. 8, 2018

(54) EXTENDING DEVICE AND MEMORY SYSTEM

(71) Applicant: Realtek Semiconductor Corporation, Hsinchu (TW)

(72) Inventors: Cheng-Yu CHEN, New Taipei City (TW); Jing-Long XIAO, Tainan City (TW); Yi-Lin HSIEH, Changhua County (TW)

(21) Appl. No.: 15/811,700

(22) Filed: Nov. 14, 2017

(30) Foreign Application Priority Data
May 3, 2017 (TW) 106114695

(51) Int. Cl. G06F 3/06

(52) U.S. Cl. CPC G06F 3/0659; G06F 3/0658; G06F 3/0673; G06F 3/0613

(57) ABSTRACT

An extending device includes a first interface unit, at least one second interface unit and a control circuit. The first interface unit is coupled to controller, the at least one second interface unit is coupled to at least one memory, and the control circuit is coupled between the first interface unit and the at least one second interface unit. The first interface unit is configured to receive a control command sent by the controller. The control circuit is configured to interpret the control command, and to control the at least one second interface unit to execute a corresponding action according to the control command.

### RELATED APPLICATIONS

This application claims priority to Taiwan Application Serial Number 106114695, filed May 3, 2017, which is herein incorporated by reference.

### BACKGROUND

### Technical Field

The present disclosure relates to a memory technology. More particularly, the present disclosure relates to an extending device and a memory system.

### Description of Related Art

In order to increase capacity of a solid state drive (SSD), many flash memory chips are often used in the SSD, thus resulting in an increased number of input/output pads (I/O pads) for a controller to be coupled to the flash memory chips. Therefore, the capacitance of the I/O pads is increased, and an operating frequency for connecting the controller to the flash memory is hard to be kept at the highest operable frequency of the controller.

### SUMMARY

An aspect of the present disclosure is to provide an extending device that includes a first interface unit, at least one second interface unit and a control circuit. The first interface unit is coupled to a controller, the at least one second interface unit is coupled to at least one memory, and the control circuit is coupled to the first interface unit and the at least one second interface unit. The first interface unit is configured to receive a control command sent by the controller. The control circuit is configured to interpret the control command, and to control the at least one second interface unit to execute a corresponding action according to the control command.

Another aspect of the present disclosure is to provide a memory system that includes a controller, at least one memory and an extending device. The extending device includes a first interface unit, at least one second interface unit and a control circuit. The first interface unit is coupled to the controller, the at least one second interface unit is coupled to the at least one memory, and the control circuit is coupled to the first interface unit and the at least one second interface unit. The controller is configured to generate a control command. The first interface unit is configured to receive the control command sent by the controller. The control circuit is configured to interpret the control command, and to control the at least one second interface unit to execute a corresponding action according to the control command.

Another aspect of the present disclosure is to provide a memory system that includes a controller, at least one memory and a repeater. The repeater is coupled between the controller and the at least one memory. A first equivalent capacitance between the repeater and the controller is smaller than a second equivalent capacitance between the repeater and the at least one memory.

In sum, the extending device may allow more memories to be disposed, so as to increase the capacity of the memory system, and the controller is still connected to the extending device at the highest frequency. Therefore, the design flexibility of the controller is improved, and the overdesign for increasing the capacity of the memory system can be effectively avoided.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a memory system in accordance with an embodiment of the present disclosure;

FIG. 2 is a flow chart illustrating a control method in accordance with an embodiment of the present disclosure;

FIG. 3 is a flow chart illustrating a control method in accordance with an embodiment of the present disclosure;

FIG. 4 is a flow chart illustrating a control method in accordance with an embodiment of the present disclosure; and

FIG. 5 is a schematic diagram of a memory system in accordance with an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In the following description and claims, the terms “coupled” and “connected,” along with their derivatives, may be used. In particular embodiments, “connected” and “coupled” may be used to indicate that two or more elements are in direct physical or electrical contact with each other, or may also mean that two or more elements may be in indirectly electrical contact with each other. The terms “coupled” and “connected” may still be used to indicate that two or more elements cooperate or interact with each other.

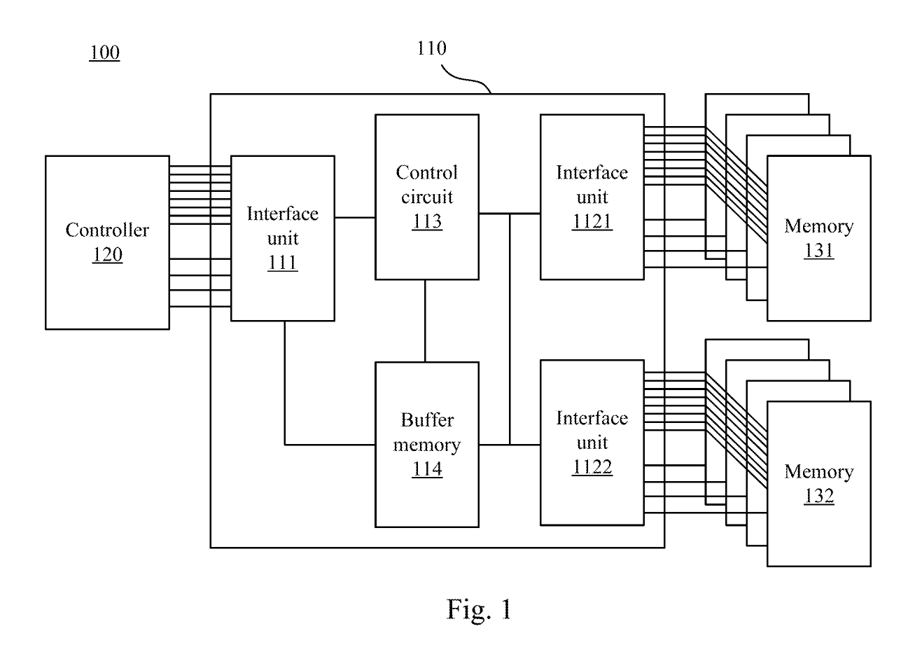

Reference is made to FIG. 1. FIG. 1 is a schematic diagram of a memory system 100 in accordance with an embodiment of the present disclosure. The memory system 100 includes an extending device 110, a controller 120 and plural memories 131 and 132. The extending device 110 is coupled between the controller 120 and the memories 131 and 132. The controller 120 controls the memories 131 and 132 through the extending device 110.

In an embodiment, extending device 110 includes interface units 111, 1121 and 1122, a control circuit 113 and a buffer memory 114. The interface unit 111 is coupled to the controller 120, the interface unit 1121 is coupled to four memories 131, the interface unit 1122 is coupled to four memories 132, and the control circuit 113 is coupled to the interface units 111, 1121 and 1122. The numbers of the interface units 1121 and 1122 and the memories 131 and 132 are merely illustrated as an example. However, the present disclosure is not limited thereto.

It is noted that because the interface unit 111 of the extending device 110 is coupled to the interface units 1121 and 1122, the number of memories coupled to a single channel of the controller 120 can therefore be increased by two times. In other words, the capacity of the memory system 100 with the extending device 110 can be effectively improved.

Moreover, input/output pads (I/O pads) of the controller 120 are coupled to the interface unit 111 of the extending device 110, and are not directly coupled to a large number of I/O pads (not shown) of the memories 131 and 132, and therefore the controller 120 can be connected to the interface unit 111 at the highest frequency of the controller 120.

The I/O pads of the memories 131 and 132 are coupled to the interface units 1121 and 1122 of the extending device 110, and therefore an equivalent capacitance between the interface units 1121 and 1122 and the memories 131 and 132 is greater than an equivalent capacitance between the interface unit 111 and the controller 120. The memories 131 and 132 may be connected to the interface units 1121 and 1122 at a frequency that is smaller than the highest frequency of the controller 120. In other words, the operating frequency of the connection between the extending device 110 and the controller 120 is not decreased when many coupled memories 131 and 132 are disposed, and may be still operated at the highest frequency of the controller 120.

As a result, the extending device 110 can allow more memories 131 and 132 to be disposed, so as to increase the capacity of the memory system 100, and the controller 120 is still connected to the extending device 110 at the highest frequency. Therefore, the design flexibility of the controller 120 is improved, and the overdesign for increasing the capacity of the memory system 100 can be effectively avoided.

In an embodiment, the interface units 1121 and 1122 are operated using time-division multiplexing (TDM).

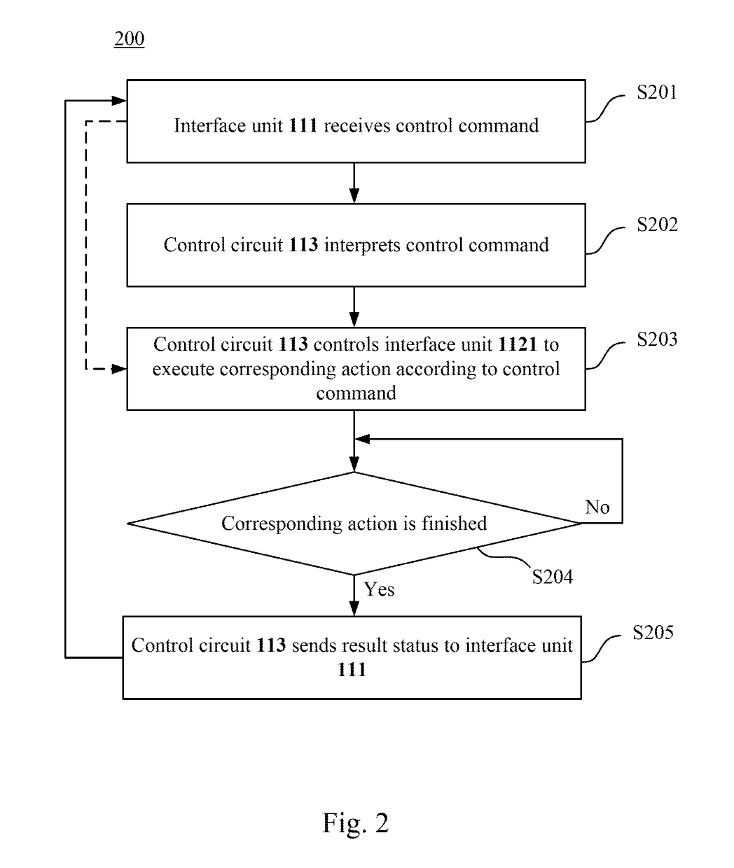

In operation, reference is made to FIGS. 1-4. FIGS. 2-4 are flow charts illustrating control methods 200-400 in accordance with some embodiments of the present disclosure. The control method 200 includes steps S201-S205, the control method 300 includes steps S301-S305, the control method 400 includes steps S401-S405, and the control methods 200-400 are applicable to the memory system 100 as shown in FIG. 1. However, those skilled in the art should understand that the aforementioned steps in the present embodiment are in any appropriate orders according to actual requirement besides the steps described in a specific order in the embodiments of the present disclosure, and even some of the steps can be performed simultaneously.

In an embodiment, the control method 200 shown in FIG. 2 illustrates a control method that does not involve data transmission. In step S201, the interface unit 111 receives a control command sent by the controller 120, and sends the control command to the control circuit 113 of the extending device 110.

In step S202, the control circuit 113 interprets the control command. For example, the control command interpreted by the control circuit 113 instructs switching the interface unit 1121 to be coupled to the interface unit 111, and then to be coupled to the controller 120.

In step S203, the control circuit 113 controls the interface unit 1121 to execute a corresponding action according to the control command. For example, the control circuit 113 controls the interface unit 1121 to be coupled to the interface unit 111 according to the control command. Alternatively, in another embodiment, the control circuit 113 may also control the interface unit 1122 to execute the corresponding action according to the control command.

In step S204, the control circuit 113 determines whether the aforementioned corresponding action is finished. If the control circuit 113 determines that the corresponding action is not finished, then the control circuit 113 continues to poll the interface unit 1121 to check whether the interface unit 1121 finishes the corresponding action.

In contrast, if the control circuit 113 determines that the corresponding action is finished, then the control circuit 113 sends a result status to the interface unit 111 in step S205.

In an embodiment, after step S205, step S201 is performed again, in which the interface unit 111 may receive another control command sent by the controller 120.

In another embodiment, if the control command interpreted by the control circuit 113 instructs the controller 120 to send plural commands (e.g., a series of commands) to the extending device 110, then the extending device 110 may skip step S202 when receiving the second to the last commands of a series of commands. In other words, steps S203-S205 are directly performed after step S201.

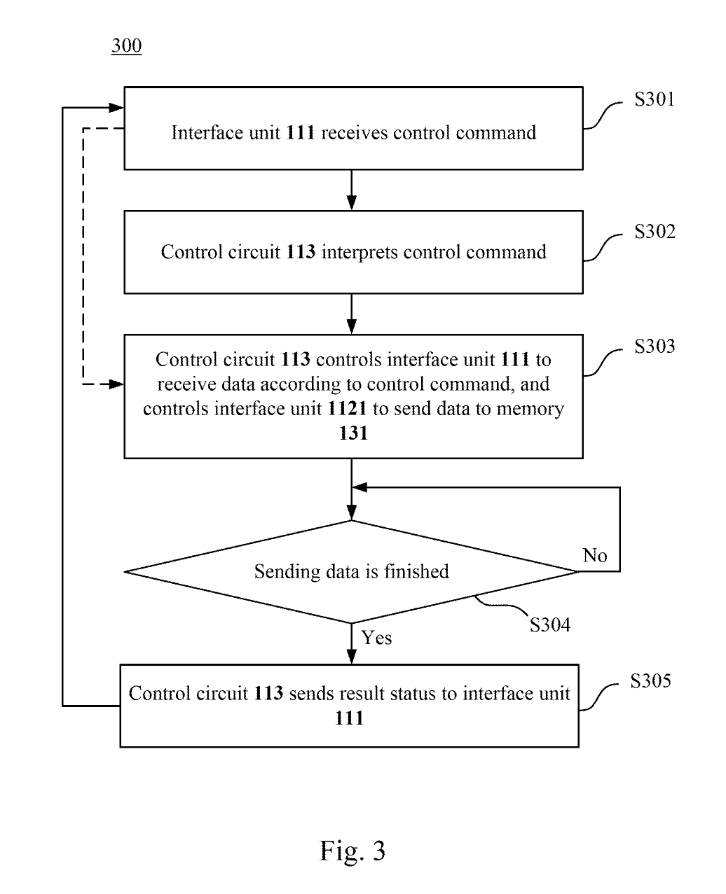

In an embodiment, the control method 300 shown in FIG. 3 illustrates a control method of writing data into the memory 131 and/or the memory 132. In step S301, the interface unit 111 receives a control command sent by the controller 120, and sends the control command to the control circuit 113 of the extending device 110.

In step S302, the control circuit 113 interprets the control command. For example, the control command interpreted by the control circuit 113 instructs writing data into the memory 131. For another example, the control command by the control circuit 113 instructs writing data into the memory 132.

In step S303, the control circuit 113 controls the interface unit 111 to receive data according to the control command, and controls the interface unit 1121 to send the data to the memory 131. Alternatively, in another embodiment, the control circuit 113 controls the interface unit 111 to receive data according to the control command, and controls the interface unit 1122 to send the data to the memory 132.

In step S304, the control circuit 113 determines whether the aforementioned corresponding action is finished. If the control circuit 113 determines that the corresponding action is not finished, then the control circuit 113 continues to poll the interface unit 1121 to check whether the interface unit 1121 finishes sending the data to the memory 131. Alternatively, in another embodiment, if the control circuit 113 determines that the corresponding action is not finished, then the control circuit 113 continues to poll the interface unit 1122 to check whether the interface unit 1122 finishes sending the data to the memory 132.

In contrast, if the control circuit 113 determines that sending the data is finished, then in step S305, the control circuit 113 sends a result status to the interface unit 111.

In an embodiment, after step S305 is finished, step S301 is performed again, in which the interface unit 111 receives another control command (e.g., another writing command) sent by the controller 120.

In another embodiment, if the control command interpreted by the control circuit 113 instructs writing plural data into the memory 131 (or the memory 132), then the extending device 110 may omits step S202 when receiving the second to the last data of the plural data. In other words, steps S303-S305 are directly performed after step S301.

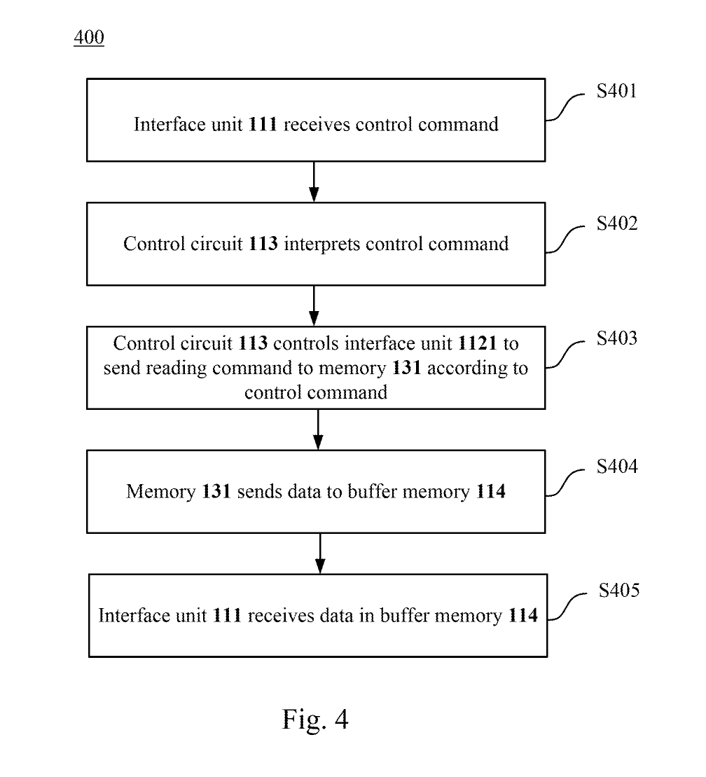

In an embodiment, the control method 400 shown in FIG. 4 illustrates a control method of reading data from the memory 131 and/or the memory 132. In step S401, the interface unit 111 receives a control command sent by the controller 120, and sends the control command to the control circuit 113 of the extending device 110.

In step S402, the control circuit 113 interprets the control command. For example, the control command interpreted by the control circuit 113 instructs reading the data from the memory 131. For another example, the control command interpreted by the control circuit 113 instructs reading the data from the memory 132.

In step S403, the control circuit 113 controls the interface unit 1121 to send a reading command to the memory 131 according to the control command. Alternatively, in another embodiment, the control circuit 113 controls the interface unit 1122 to send the reading command to the memory 132 according to the control command.

In step S404, the memory 131 that receives the reading command sends data to the buffer memory 114 through the interface unit 1121 for storage. Alternatively, in another embodiment, the memory 132 that receives the reading command sends the data to the buffer memory 114 through the interface unit 1122 for storage.

Then, in step S405, the interface unit 111 receives the data in the buffer memory 114. Specifically, the control circuit 113 firstly checks whether there are data stored in the buffer memory 114. If data are stored in the buffer memory 114, then the control circuit 113 controls the interface unit 111 to receive the data from the buffer memory 114 for reading the data.

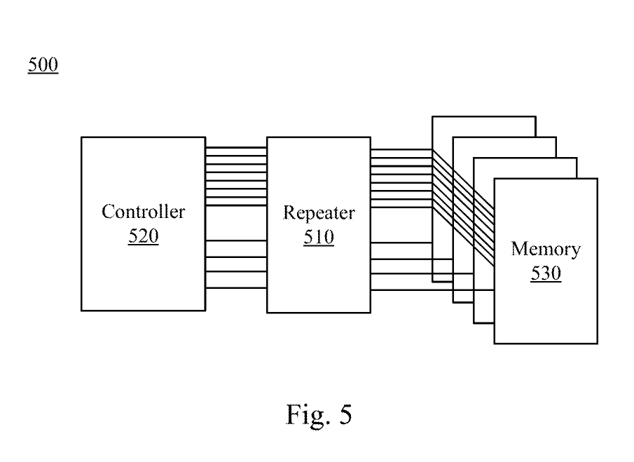

Reference is made to FIG. 5. FIG. 5 is a schematic diagram of a memory system 500 in accordance with an embodiment of the present disclosure. The memory system 500 includes a repeater 510, a controller 520 and memories 530. The repeater 510 is coupled between the controller 520 and the four memories 530. The controller 520 controls the four memories 530 through the repeater 510. An equivalent capacitance between the repeater 510 and the controller 520 is smaller than an equivalent capacitance between the repeater 510 and the memories 530.

It is noted that, if the four memories 530 are directly coupled to the controller 520, the four memories 530 may be unmatched with the specification of a coupling capacitor of the controller 520. The repeater 510 coupled between the controller 520 and the memories 530 can effectively overcome the mismatch specification problem between the controller 520 and the memories 530, and therefore the controller 520 can normally operate the four memories 530. The number of the memories 530 is merely illustrated as an example. However, the present disclosure is not limited thereto.

In practice, the memory systems 100 and 500 may be solid state drives (SSDs), the controllers 120 and 520 may be controllers of the SSDs, and the memories 131, 132 and 530 may be flash memory chips.

In sum, the extending device 110 can increase number of the memories 131 and 132 to increase the capacity of the memory system 100, and the controller 120 is still connected to the extending device 110 at the highest frequency. Therefore, the design flexibility of the controller 120 is improved, and the overdesign for increasing the capacity of the memory system 100 can be effectively avoided. Moreover, the repeater 510 can effectively overcome the specification mismatch problem between the controller 520 and the memories 530.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An extending device, comprising:
a first interface unit coupled to a controller and configured to receive a control command sent by the controller;
at least one second interface unit coupled to at least one memory; and
a control circuit coupled to the first interface unit and the at least one second interface unit, and configured to interpret the control command and to control the at least one second interface unit to execute a corresponding action according to the control command.

2. The extending device of claim 1, wherein the control circuit is further configured to send a result status to the first interface unit after the corresponding action is finished.

3. The extending device of claim 1, wherein the control circuit is further configured to control the first interface unit to receive data according to the control command, and to control the at least one second interface unit to send the data to the at least one memory, so as to write the data into the at least one memory.

4. The extending device of claim 3, further comprising:
a buffer memory coupled to the control circuit, the first interface unit and the at least one second interface unit, and configured to store the data, wherein the control circuit is further configured to store the data in the buffer memory according to the control command, and to control the at least one second interface unit to receive the data from the buffer memory.

5. The extending device of claim 1, wherein the control circuit is further configured to control the at least one second interface unit to receive data from the at least one memory according to the control command, so as to read the data from the at least one memory.

6. The extending device of claim 5, further comprising:
a buffer memory coupled to the control circuit, the first interface unit and the at least one second interface unit, and configured to store the data, wherein the control circuit is further configured to store the data in the buffer memory according to the control command, and to control the first interface unit to receive the data in the buffer memory.

7. The extending device of claim 1, wherein the first interface unit is connected to the controller at a first frequency, and the at least one second interface unit is connected to the at least one memory at a second frequency.

8. The extending device of claim 7, wherein the first frequency is greater than the second frequency.

9. The extending device of claim 1, wherein the at least one second interface unit is operated using time-division multiplexing (TDM).

10. A memory system, comprising:
a controller configured to generate a control command;
at least one memory; and
an extending device, comprising:
a first interface unit coupled to the controller and configured to receive the control command sent by the controller;
at least one second interface unit coupled to the at least one memory; and
a control circuit coupled to the first interface unit and the at least one second interface unit, and configured to interpret the control command, and to control the at least one second interface unit to execute a corresponding action according to the control command.

11. The memory system of claim 10, wherein the control circuit is further configured to send a result status to the first interface unit after the corresponding action is finished.

12. The memory system of claim 10, wherein the control circuit is further configured to control the first interface unit to receive data according to the control command, and to control the at least one second interface unit to send the data to the at least one memory, so as to write the data into the at least one memory.

13. The memory system of claim 12, further comprising:
a buffer memory coupled to the control circuit, the first interface unit and the at least one second interface unit, and configured to store the data, wherein the control circuit is further configured to store the data in the buffer memory according to the control command, and to control the at least one second interface unit to receive the data from the buffer memory.

14. The memory system of claim 10, wherein the control circuit is further configured to control the at least one second interface unit to receive data from the at least one memory according to the control command, so as to read the data from the at least one memory.

15. The memory system of claim 14, further comprising:
a buffer memory coupled to the control circuit, the first interface unit and the at least one second interface unit, and configured to store the data, wherein the control circuit is further configured to store the data in the buffer memory according to the control command, and to control the first interface unit to receive the data from the buffer memory.

16. The memory system of claim 10, wherein the first interface unit is connected to the controller at a first frequency, and the at least one second interface unit is connected to the at least one memory at a second frequency.

17. The memory system of claim 16, wherein the first frequency is greater than the second frequency.

18. The memory system of claim 10, wherein the at least one second interface unit is operated using time-division multiplexing (TDM).

19. The memory system of claim 10, wherein a first equivalent capacitance between the first interface unit and the controller is smaller than a second equivalent capacitance between the at least one second interface unit and the at least one memory.

20. A memory system, comprising:
a controller;
at least one memory; and
a repeater coupled between the controller and the at least one memory,
wherein a first equivalent capacitance between the repeater and the controller is smaller than a second equivalent capacitance between the repeater and the at least one memory.
